(19) United States
(12) Patent Application Publication
(10) Pub. No.: US 2009/0089744 A1
(43) Pub. Date: Apr. 2, 2009

(54) Method and apparatus for generating error-correcting and error-detecting codes using zero-divisors and units in group rings

(75) Inventor: Ted Hurley, Galway (IE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: National University of Ireland, Galway (IE)

(21) Appl. No.: 11/919,810

(22) PCT Filed: May 4, 2006
(86) PCT No.: PCT/IE2006/000046

§ 371 Date: Nov. 2, 2007

(30) Foreign Application Priority Data
May 4, 2005 (IE) 2005/0277

(51) Int. Cl. G06F 9/44

(52) U.S. Cl. 717/106

(57) ABSTRACT

A method and apparatus for generating a code having properties specific to its intended use, the method comprising the steps of: selecting a group from a set of groups; selecting a ring from a set of rings; forming a group ring from said select group and selected ring; selecting a generator element from said group ring, wherein said selection is based on the desired properties of the code to be generated; and inputting said selected generator element into a code generation process to obtain a corresponding check element.

### FIELD OF THE INVENTION

The present invention relates to codes, in particular the generation of codes including error-correcting and error-detecting codes.

### BACKGROUND TO THE INVENTION

Coding theory, and in particular the use of error-correcting and error-detecting codes, is one of the central elements of modern telecommunications systems, along with source coding, modulation and encryption. The use of error-correcting and error-detecting codes is a fundamental tool in communications systems.

Error-correcting codes are used to protect data during communication across space and time. These codes may be used to transmit data safely across space over “noisy” channels, such as wireless communication channels, fibre optic or Ethernet links, digital cable or Digital Subscriber Line (DSL), satellite communication channels, or deep space communication channels. The noisiness of the channel means that there is a possibility that the data will be damaged or disrupted during transmission. Error-correction codes are also used to protect data communications across time, for example by ensuring that data on data storage media, such as standard hard drives, disks, CDs, DVDs and computer memory, is not corrupted over time.

One of the most basic forms of coding for error control is the adding of a parity check bit to a string of binary data. This can detect when one error has occurred. However if two errors have occurred the recipient will not be aware that any error has occurred. In general, a greater number of error control bits provided by a code results in better error detection/correction ability, but lower information content per transmission. It is therefore desirable to generate codes which provide a balance between error handling ability and information content.

Most existing codes in use are cyclic codes. Cyclic codes, which are sometimes referred to as polynomial codes, are as it turns out zero-divisor group ring codes of the cyclic group. A group ring in general is an algebraic structure wherein for a given group G and given ring R the group ring RG consists of all elements of the form

$${\sum }_{g ∈ G} α ( g ) g$$

with α(g)∈R and only a finite number of the α(g) are non-zero. When G={g₁, g₂ . . . , gₙ} is finite then RG consists of all

$${\sum }_{i = 1}^{n} {\dot{α}}_{i} {g}_{i}$$

with αᵢ∈R.

The group ring RG can thus be considered as the module over R with basis consisting of the elements of G and with a multiplication determined by the convolutional type multiplication of the elements of G together with distributive laws. A submodule of any-module is a non-empty subset of the module which is itself a module. When R is a field, RG is often called a group algebra.

It is known that group rings may be considered as rings of matrices.

A group ring, RG, of a group G over a ring R is a ring of certain matrices, called RG-matrices, over R.

Algebraically and more precisely if G is a group of order n and R is a ring there exists an injection φ: RG→R_{n×n} mapping the group ring RG to a subring of the ring of n×n matrices over R; this subring of R_{n×n} is the set of RG-matrices. If u∈RG then denote φ(u) by U, i.e. denote the image of u under φ by the corresponding capital letter. If also U is an RG-matrix then its inverse image under φ is denoted by u, the corresponding lower case letter. It is important to note that once the first row (or column) of the RG-matrix is known then the whole matrix is known. Thus given an element u of a group ring and the group multiplication the corresponding matrix U may be determined.

Cyclic codes include such important codes as BCH, Reed-Solomon, Golay and Hamming codes. Many existing codes are typically generated from matrices which come from zero-divisors of the cyclic group ring.

Existing codes are also commutative codes and it is an object of the present invention to provide non-commutative codes.

The existing methods, in particular if the code is randomly generated, often give the code in terms of a check matrix and it can be computationally impossible to then provide the generator matrix. It is a further object of the present to provide the check and generator matrices algebraically and simultaneously.

It is a further object of the present invention to provide a method for generating many more new, useful and interesting codes, including Low Density Parity Check (LDPC) codes, Self-dual type codes, and Orthogonal codes.

### SUMMARY OF THE INVENTION

Accordingly, the invention provides a method of generating a code having properties specific to its intended use, the method comprising the steps of:
a) selecting a group from a set of groups;
b) selecting a ring from a set of rings;
c) forming a group ring from said select group and selected ring;
d) selecting a generator u element from said group ring, wherein said selection is based on the desired properties of the code to be generated; and
e) inputting said selected generator element u into a code generation process to obtain a corresponding check element.

The code to be generated may be a zero-divisor code of a non-cyclic group, wherein the step of selecting a generator element comprises selecting a zero-divisor element.

Alternatively, the code to be generated may be a unit code, wherein the step of selecting a generator element comprises selecting a unit element.

The code to be generated may be a low density parity check (LDPC) code, wherein the step of selecting a generator element comprises selecting an element having a small number of non-zero coefficients compared to the size of the group.

The code properties may include code distance, and/or code length, and/or code rate.

The method may further comprise the step of:
f) mapping said generator element and said check element onto a corresponding pair of encoding and decoding matrices.

Desirably, the method may further comprise the step of:
g) using the encoding and decoding matrices to carry out an evaluation of the generated codes.

In addition to calculating code rate, the evaluation may comprise calculating code distance and/or code girth.

Desirably, the method further comprises the step of:
h) repeating steps a) to e) using the results of the evaluation as feedback when carrying out steps a) and b).

In addition, or alternatively, steps a) and b) may comprise the use of the properties of the system which the generated code is intended for use in the selection process. In addition, or alternatively, steps a) and b) comprise the use of predetermined selection criteria in their selection process.

Step d) may further comprise the step of:

determining whether said selected generator element u is a zero-divisor.

Step d) may further comprise the step of:

determining a matching element v of the group ring such that uv=0, if sad selected generator element u is a zero-divisor element, or
determining a matching element v of the group ring such that uv=1, if said generator element u is a unit.

Step e) may then further comprise the step of:

inputting said matching element v into said generation process.

The invention further provides apparatus for generating a code having properties specific to its intended use, the apparatus comprising:

means for selecting a group from a set of groups;
means for selecting a ring from a set of rings;
means for forming a group ring from said select group and selected ring;
means for selecting a generator element u from said group ring, wherein said selection is based on the desired properties of the code to be generated; and
a code generator adapted to receive said selected generator element u and to generate a corresponding check element.

According to one aspect of the invention, the code to be generated may be obtained from a zero-divisor code of a non-cyclic group, and the means for selecting a generator element u may be adapted to select a zero-divisor element.

According to another aspect of the invention, the code to be generated may be obtained from a unit code, and the means for selecting a generator element u may be adapted to select a unit element.

According to a further aspect, the code to be generated may be a low density parity check (LDPC) code, and the means for selecting a generator element may be adapted to select an element having a small number of non-zero coefficients compared to the size of the group.

The code properties may include code distance, and/or code length, and/or code rate.

The apparatus may further comprise:

means for mapping said generator element and said check element onto a corresponding pair of encoding and decoding matrices.

Desirably, the apparatus further comprises:

a generated code analyser for evaluating the generated codes using the encoding and decoding matrices.

The generated code analyser may be adapted to calculate code rate. Alternatively, or in addition to calculating code rate, the generated code analyser may be adapted to calculate code girth and/or code distance.

In accordance with one aspect, the means for selecting a group and said means for selecting a ring may be adapted to use the results of the generated code analyser as feedback.

The means for selecting a group and said means for selecting a ring may be adapted to use properties of the system which the generated code is intended for use.

The means for selecting a group and said means for selecting a ring may be adapted to use user input in their selection process.

Desirably, the means for selecting a generator element from said group ring further comprises: means for determining whether said selected generator element u is a zero-divisor element.

Preferably, the means for selecting a generator element from said group ring is adapted to:

determining a matching element v of the group ring such that uv=0 if said selected generator element u is a zero-divisor element, and
determining a matching element v of the group ring such that uv=1, if said selected generator element u is a unit.

Preferably the code generator is adopted to receive said matching element v and use said matching element in its code generating process.

It will be appreciated that a code generated by the method of the invention may be used to encode data for transmission over a communication channel in a communication system.

It will be further appreciated that a code generated by the method of the invention may be used to encode data for storage on data storage media.

In one such use, the data may be digital data.

In will also be appreciated that a code generated by the method of the invention may be used to encode an encrypted message, said encrypted message having been encrypted using public key cryptography, wherein said generator u acts as a public key and said check element acts as a private key.

It will be appreciated that the method of the present invention allows generator and check matrices to be easily obtained for the new generated codes. This is achievable since many of the group ring codes can be given in terms of matrices, using the relationship which has been derived between group rings and certain matrices.

The use of group ring codes in the manner of the invention also enables new self-dual and new Low Density Parity Check (LDPC) codes to be derived. This enables new codes of these types which did not exist prior to the invention to be constructed algebraically with this method.

The advantages of being able to generate codes “to order” are unlimited. For example, in accordance with the invention, it is possible to select a generator element from said group ring, to ensure that the code generated will be, for example, one that investigation has shown to have good distance. One such code could be a LDPC code derived using short group ring elements. In another example, it may be possible to select a generator element from said group ring, to ensure that the code generated will have a required rate, for example if a large rate was required in order to improve speed. Likewise, with relation to code distance, it may be preferable to have a code with a large distance so as to minimise code correction time.

It will be appreciated that the method of the invention is not limited to the generation of codes from group ring matrices. The method may be used with any invertible matrix. Accordingly, the invention further provides a method of generating a code having properties specific to its intended use, the method comprising the steps of:
i) selecting a generator element from a non-singular matrix, wherein said selection is based on the desired properties of the code to be generated; and
j) inputting said selected generator element into a code generation process to obtain generator and check matrices.

As will be appreciated by one of skill in the art, the present invention may be embodied as a method, data processing system, or computer program product. Accordingly, the present invention make take the form of an entirely hardware embodiment, an entirely software embodiment or an embodiment combining software and hardware aspects. Furthermore, the present invention may take the form of a computer program product on a computer-readable storage medium having computer-readable program code means embodied in the medium.

The present invention will now be described with reference to the accompanying drawings in which embodiments of the invention are shown and by examples. The invention may, however, be embodied in many different forms and should not be construed as limited to the embodiments set forth herein; rather, these embodiments are provided so that this disclosure will be thorough and complete, and will fully convey the scope of the invention to those skilled in the art.

### BRIEF DESCRIPTION OF THE DRAWINGS

FIG. 1 is a flow chart representing a code generation method in accordance with one aspect of the invention.

FIG. 2 illustrates the element selection and code generation processes of the method shown in FIG. 1.

### DETAILED DESCRIPTION OF THE DRAWINGS

The invention provides a new method and system for the development and deployment of codes. One possible application of codes to be generated may be for error-correction or error-detection in digital communication and storage systems.

The new types of codes generated by the method of the invention are zero-divisor and units in the algebraic structure called a group ring.

These units and zero-divisors in the group ring are used to obtain matrices. These matrices are generator matrices—used in the encoding process—and parity-check matrices—used in the decoding process.

### Group Ring Codes

Let RG be the group ring of the group G over the ring R. R will quite often be a field, but is not restricted as such. If R is a field, then RG is often referred to as a group algebra. The group ring RG is said to be a module over R. A submodule is a non-empty subset which is itself a module.

Let G={g₁, g₂, . . . , gₙ}. This set is the basis for the module RG over the ring R. Let u∈RG.

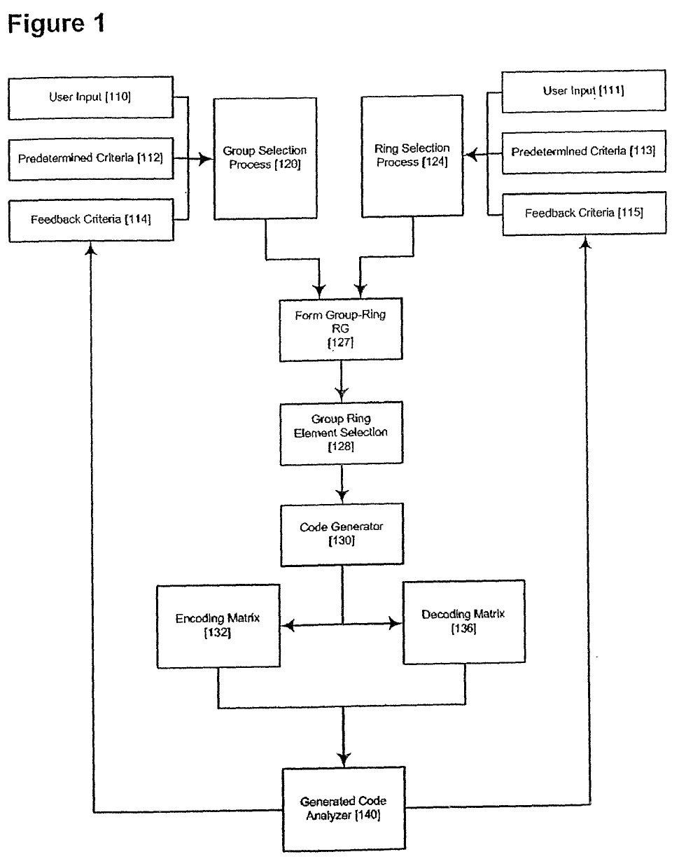

FIG. 1 shows the steps of a code generation method according to one aspect of the invention.

The method comprises a group selection process 120 and a ring selection process 124 which allows a suitable combination of a group and a ring to be determined for a group-ring formation step 127. Both selection processes may incorporate user input 110, 111 predetermined selection criteria 112, 113 or feedback criteria 114, 115 to assist in the determination of a suitable group and ring combination for code generation.

Once a suitable combination of a group and a ring have been determined they are input to a group ring forming process 127. Once a group ring has been formed it is next required to select a particular element from said group ring 128 according to certain criteria.

The selected element, known as the generator element, is next input to a code generating process 130 yielding a corresponding check element. Then, according to the present invention, said generator and check elements can be mapped onto a corresponding pair of encoding 132 and decoding 136 matrices, as an encoding matrix 132 and allows a corresponding check, or decoding matrix to be generated 136. This code generation step 130 represents the main invention described herein.

In certain cases said encoding and decoding matrices 132, 136 may be employed by a code analyser 140 to allow testing and empirical evaluation of the generated codes, including calculations of their properties such as the code rate, girth and distance. These data may be provided to the next cycle of code generation via the feedback criteria 114, thus allowing a selective refinement of the code generation process in certain embodiments.

In alternative embodiments the feedback may derive from an active communications link or data interface employing code-based error correction and/or encryption. In such embodiments the feedback criteria 114,115 may also depend on properties of said communications link or data interface. Thus the disclosed invention could be adapted to allow the dynamic generation of codes in response to changes in link/interface conditions.

Once a final set of codes with satisfactory properties has been determined these may be output for use in prior art communications and encryption systems.

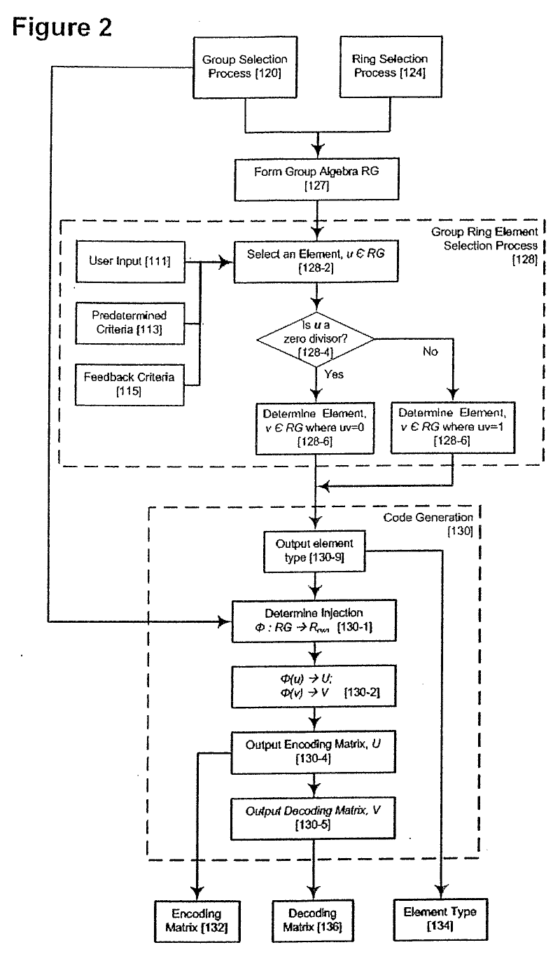

The element selection 128 and code generation 130 steps are described in detail below with respect to FIG. 2. Firstly we remark that step 127 which forms a group-ring, will also determine the elements of the group ring. Mathematical details are included later. Note that, in certain embodiments of the present invention where a complex group-ring structure is employed additional process steps may be required after step 127 to eliminate certain elements prior to the main element selection process 128. However, in the most useful embodiments of the invention, with known applications, the group-ring will normally generate a relatively small set of elements with particular properties determined from the group and ring employed as inputs under steps 120 and 124.

FIG. 2 illustrates the element selection and code generation processes for the case where the group ring is a group algebra. This embodiment is particularly useful for modern communication or digital information processing systems where digital data is employed. Typically the ring employed will be [symbol] ₂ which has the widest applicability, although other fields will be relevant for certain specialized communications or information processing systems.

The element selection process 128 comprises the additional sub-steps of selecting a generator element 128-2 from the set of elements of the group ring formed in step 127. This element, u, must then be tested to determine if it is a zero-divisor element 128-4; in the case where this is so it is possible to determine a matching element of the group ring, v, such that uv=0, 128-6. These elements and the fact that the element u is a zero-divisor will then be input to the next step of code generation 130.

If the selected element is not a zero-divisor element, then, given that we are describing an embodiment where the group-ring is restricted to a group-algebra, it must be a unit element. In this case we determine a matching element of the group ring, v, such that uv=1. In 128-8 and these elements will, alternatively, be input into the code generation step 130.

We remark that in certain embodiments it may be desirable to restrict the elements to either zero-divisors or units depending on the application. In many cases this will occur naturally based on the group and ring selected during steps 120 and 124.

The code generation step 130 will next be described. This step relies mainly on the mapping of the group-ring elements, u and v, onto a corresponding group-ring matrix 130-2 through an injection, φ: RG→R_{n×n}. Several practical examples of implementations are given later. In actuality, the form of this injection, or mapping, is pre-determined by the properties of the group which is selected in step 120 but it must be realised computationally under step 130-1. Where an embodiment of the invention is restricted to, say, a single family of groups, such as the dihedral groups of order n, this injection can be realized as a simple computer script with a single input parameter n. However, in more complex embodiments it may be necessary to implement this injection using a symbolic processing program such as MATEMATICA, MAPLE or GAP, or by a stand-alone computer program or a combination of both, as will be known to those skilled in the art.

After step 130-2 the code generator needs to output the matrix corresponding to group-ring element u as the encoding matrix 130-4 and the matrix corresponding to group-ring element v as the decoding element 130-5. These outputs, 132 and 136 and the form of the generated code (zero-divisor or unit) 134 form the outputs of the code generation process 130.

### EXAMPLES OF IMPLEMENTATION OF THE METHOD OF THE PRESENT INVENTION

### Example of a Zero-Divisor Code Using the Dihedral Group of Order 8

The dihedral group of order 8, D₈, is non-commutative. Its elements are {1, y, y², y³, x, xb, xb², xb³} where y⁴=1, x²=1, yx=xy⁻¹. The RG-matrix of this group G has the form

$$( \begin{matrix}A & B \\ B & A\end{matrix} )$$

where A, B have the following forms. (A is circulant and B is a Hankel-type.)

$$A = ( \begin{matrix}p & q & r & s \\ s & p & q & r \\ r & s & p & q \\ q & r & s & p\end{matrix} ) and B = ( \begin{matrix}a & b & c & d \\ b & c & d & a \\ c & d & a & b \\ d & a & b & c\end{matrix} ) .$$

There are many choices for the coefficients. Suppose for example we choose the element u=b²+a+ab+ab² and v=1+b+b³+ab³. Then over R= [symbol] ₂, uv=0. This corresponds to letting p=0=q=s, r=1 in A and a=1=b=c, d=0 in B.

This gives the RG matrix corresponding to u as follows:

$$P = ( \begin{matrix}0 & 0 & 1 & 0 & 1 & 1 & 1 & 0 \\ 0 & 0 & 0 & 1 & 1 & 1 & 0 & 1 \\ 1 & 0 & 0 & 0 & 1 & 0 & 1 & 1 \\ 0 & 1 & 0 & 0 & 0 & 1 & 1 & 1 \\ 1 & 1 & 1 & 0 & 0 & 0 & 1 & 0 \\ 1 & 1 & 0 & 1 & 0 & 0 & 0 & 1 \\ 1 & 0 & 1 & 1 & 1 & 0 & 0 & 0 \\ 0 & 1 & 1 & 1 & 0 & 1 & 0 & 0\end{matrix} ) = ( \frac{W}{U} )$$

P is a zero-divisor and it also clearly has rank 4. The RG matrix corresponding to v is as follows:

$$Q = ( \begin{matrix}1 & 1 & 0 & 1 & 0 & 0 & 0 & 1 \\ 1 & 1 & 1 & 0 & 0 & 0 & 1 & 0 \\ 0 & 1 & 1 & 1 & 0 & 1 & 0 & 0 \\ 1 & 0 & 1 & 1 & 1 & 0 & 0 & 0 \\ 0 & 0 & 0 & 1 & 1 & 1 & 0 & 1 \\ 0 & 0 & 1 & 0 & 1 & 1 & 1 & 0 \\ 0 & 1 & 0 & 0 & 0 & 1 & 1 & 1 \\ 1 & 0 & 0 & 0 & 1 & 0 & 1 & 1\end{matrix} ) = ( T \vert U )$$

We can thus have an encoding R⁴→R⁸ by: Let x=α₁g₁+α₂g₂+α₃g₃+α₄g₄ and x [symbol] xu. c is a codeword if and only if cv=0. In matrix form it is seen that the top section, W, of P can be considered to be the generator matrix and the transpose of the second part of Q, U^{t} is the check matrix. This code has distance d=3, length 8 and dimension 4.

The construction of the group ring of the dihedral group can also be embodied using computer algebra package as described in the following example which is more general.

### Dihedral Example of LDPC Code Using Bicyclic Units

Take the dihedral group D₂ₙ=<a,b:a²,bⁿ=1,ab=b⁻¹a> of order 2n. Note that n can be as big as we like. By taking a, b as above we get the bicyclic unit 1+(1−a)bâ which in this case is u=1−b+bⁿ⁻¹+ab−abⁿ⁻¹ from the relations. There are only 5 elements in this unit. Its inverse is u⁻¹=1+b−bⁿ⁻¹−ab+abⁿ⁻¹.

We can construct the group ring of this group in the Computer Algebra package GAP as follows:

#This GAP program constructs the group ring of the Dihedral Group of order n.
# n is first chosen and must be even. We also choose it to have the form
#n=2p for a prime p but this is not necessary in general.
# The field here is F, and we must define
#this first. Here we take
#F=GF(2) the binary field of two elements, but other possibilities exist.
#The element f is chosen because we know its inverse exists as it is
#bicyclic unit.

### F:=GF(2);

#make sure n has been defined.
n;

### DN:=DihedralGroup(n);

### RDM:=FreeMagmaRing(F,DN);

### emb:=Embedding(DN, RDM);;

gens:=List(GeneratorsOfGroup(DN), x→x̂emb );;
x:=gens[1];
y:=gens[2];

### one:=Identity(RDM);

u:=one −y+ŷ(n/2−1)+x*y−x*ŷ(n/2−1);
#We know from theory that the inverse of u has the following form:
uinverse:=one+y−ŷ(n/2−1)−x*y +x*ŷ(n/2−1);
#Just check that uinverse is the inverse of u
u*uinverse; #Answer should be ‘one’.
#We could also seek the inverse of u if we don't know whether or not it has
#an inverse by the following cammand.
uinverse:=Inverse(u);
# Once we have u and it inverse we can then go to construct the unit code
# generator matrix and check as described.

Then the matrix of u, U, is given directly as follows by applying results in [1]:

$$( \begin{matrix}1 & - 1 & 0 & … & 0 & 1 & 0 & 1 & 0 & … & 0 & - 1 \\ 1 & 1 & - 1 & 0 & … & 0 & 1 & 0 & 0 & … & - 1 & 0 \\ ⋮ & ⋮ & ⋮ & ⋮ & ⋮ & ⋮ & ⋮ & ⋮ & ⋮ & ⋮ & ⋮ & ⋮ \\ - 1 & 0 & 0 & … & 1 & 1 & - 1 & 0 & 1 & … & 0 & 0 \\ 0 & 1 & 0 & … & 0 & - 1 & 1 & - 1 & 0 & … & 0 & 1 \\ 1 & 0 & 0 & … & - 1 & 0 & 1 & 1 & - 1 & 0 & … & 0 \\ ⋮ & ⋮ & ⋮ & ⋮ & ⋮ & ⋮ & ⋮ & ⋮ & ⋮ & ⋮ & ⋮ & ⋮ \\ - 1 & 0 & 1 & … & 0 & 0 & - 1 & 0 & 0 & … & 1 & 1\end{matrix} ) = ( \begin{matrix}A & B \\ B & A\end{matrix} ) ( say )$$

Consider the (2n, n) code C derived from this unit as described previously. The generator matrix of this code is (A, B), the top part of U, and is an n×2n matrix. It automatically has rank n.

The matrix of u⁻¹ is

$$( \begin{matrix}1 & 1 & 0 & … & 0 & - 1 & 0 & - 1 & 0 & … & 0 & 1 \\ - 1 & 1 & 1 & … & 0 & 0 & - 1 & 0 & 0 & … & 1 & 0 \\ ⋮ & ⋮ & ⋮ & ⋮ & ⋮ & ⋮ & ⋮ & ⋮ & ⋮ & ⋮ & ⋮ & ⋮ \\ 1 & 0 & 0 & … & - 1 & 1 & 1 & 0 & - 1 & … & 0 & 0 \\ 0 & - 1 & 0 & … & 0 & 1 & 1 & 1 & 0 & … & 0 & - 1 \\ - 1 & 0 & 0 & … & 1 & 0 & - 1 & 1 & 1 & … & 0 & 0 \\ ⋮ & ⋮ & ⋮ & ⋮ & ⋮ & ⋮ & ⋮ & ⋮ & ⋮ & ⋮ & ⋮ & ⋮ \\ 1 & 0 & - 1 & … & 0 & 0 & 1 & 0 & 0 & … & - 1 & 1\end{matrix} ) = ( \begin{matrix}C & D \\ D & C\end{matrix} ) ( say )$$

The check matrix of the code C is (D^{t}, C^{t}) which is the transpose of the matrix to the right of the vertical line above.

These matrices are ‘sparse’.

All the above holds for any ring R. In particular consider R= [symbol] ₂=GF(2), the binary field. Here it is noted that u⁻¹=u and that A=C and B=D. If we consider this as an encoding Rₙ→R₂ₙ we have a (2n, n) code where the generator and check matrices are (A, B) and the transpose of (B^{t}, A^{t}) respectively. This is an LDPC code which is also self-check.

### Example of the Construction of a Unit-Derived Cyclic Code Using the Group Ring Construction

The following MAPLE program constructs a cyclic LDPC unit-derived code. The generator matrix is obtained from A and the check matrix is obtained from B.

#Enter n; make sure n>12. If n is not >12 then formula for fh should
#change. To be sure to get
#an inverse take n=2p, for a prime p.
n; #check that n has been entered.
m:=trunc((n)/2);
f:=ĝn−1;
fh:=1+ĝ2+ĝ5+ĝ(m)+ĝ(m +4);

### j:=Gcdex(fh,f,g, ‘s’, ‘t’) mod 2;

fhinverse:=s;
id:=rem(fh*fhinverse,f,g);
with(LinearAlgebra);
#read “circ_poly.map”; This function is given below.
circ_poly:=proc(f, g, n)
description “form a circulant matrix from the polynomial in z2”;
   local i, j, M, term;
   M:=Matrix(n+1,n+1);
for i from 0 to n do
   for j from 0 to n do
   M[j+1, 1+((i+j) mod (n+1))]:=coeff(f,g,i);
   od;
   od;
   return M;
   end proc;
   A:=circ_poly(fh,g,n−1);
   B:=circ_poly(fhinverse,g,n−1);
   # The generator matrix is
   #taken from A and the check matrix from B. The rate of the code is
   #determined by which part of A we use — see description of unit group code.

### # Below we use

#rate=m/n which is ½ when n is even and is ½−½n when n is odd.
#The matrices should be converted to mod 2 matrices when used.

### GenCode:=A[1 . . . m,1 . . . n];

CheckCode1:=B[1 . . . n,(m+1) . . . n];

### CheckCode:= Transpose(CheckCode1);

### Use of Alternating Type Units to Get LDPC Codes

Another source of good LDPC codes may be obtained from the alternating units in a cyclic group ring. See [3] for a complete description of alternating units.

These are units of the form

$${g}_{c} ( x ) = {\sum }_{i = 0}^{c - 1} {( - x )}^{i} = 1 - x + {x}^{2} - … + {( - 1 )}^{c - 1} {x}^{c - 1}$$

in the cyclic group of order n where 2<c<n with n odd and (c, 2n)=1 (so that c must be odd also).

Here when c is small, g_{c}(x) has only a small number of non-zero coefficients compared to n—and g_{c}(x)⁻¹ has a large number of coefficients.

The matrix corresponding to g_{c}(x) will then have only a small number elements in each row and column and the matrix corresponding to g_{c}(x)⁻¹ will generally have of the order of n/2 elements in each row and column.

We thus take our generator matrix appropriately from the unit g_{c}(c)⁻¹ and our check matrix from g_{c}(x).

The inverse of an alternating unit may be obtained using the Euclidean Algorithm and thus for a given alternating unit (which can be chosen of small weight) the inverse may be constructed very quickly.

The following program produces unit alternating elements from which unit codes are derived:

# This programme constructs an alternating unit of a cyclic group ring, finds
#its inverse and works out the corresponding RG-matrices which produce the
#generating and check matrices. The n is the order of the cyclic group and
#the c is a number such that 2<c<n with (c,2n)=1.
#There is no restriction on the field and it can be considered as a code over
#the integers. The algorithm is very fast and large numbers can be used.
n; # make sure n has been entered
c; #make sure c has been entered
g:=sum((−x)̂i, i=0 . . . c−1);
f:=x̂n−1;
j:=gcdex(g,f,x, ‘s’, ‘t’);
ginverse:=s;
id:=rem(g*ginverse,f,x);
A:=circ_poly(g,x,n−1);
B:=circ_poly(ginverse,x,n−1);
#A gives the check matrix in this case and B gives the generating matrix.
#If c is small compared to n, we get a LDPC code.

For example if n=17, c=3 then

g_{c}(x)=1−x+x²

but

g_{c}(x)⁻¹=x+x²−x⁴−x⁵+x⁷+x⁸−x¹⁰−x¹¹+x¹³+x¹⁴−x¹⁶

Then the check matrix has only 3 elements in each row and column.

### Other LDPC Code Examples

We can similarly construct other LDPC codes by considering other units and zero-divisors. The following is an interesting one.

It is useful for LDPC codes to have large girth, at least greater than or equal to 6. Consider then the cyclic group Cₘ of order m generated by x and form the direct product G=Cₘ×C₂ where C₂ is generated by y. Form the group ring GF(3)G of G over the field of three elements. The element f(x)=1+x²−x*y+x²*y has an inverse in this group ring. It is constructed in such a way that the dimension of the corresponding matrix is large. The matrix corresponding to f(x) will be sparse although its inverse will not be sparse—the inverse will have greater than m/2 elements in each row and column. We form the code of dimension m as described above for forming unit group ring codes using the inverse to obtain the generating matrix and f(x) to obtain the check matrix.

The following program produces the group ring, the relevant unit and its inverse.

# This is a GAP program to construct the group ring of the direct product of a
#cyclic group of order n, C_n, and the cyclic group of order 2,C_{—}2.
# over the field F. In this case we take F to be GF(2), the binary field on
#two elements. The size n required must first be entered and stored. The
#element f in the group ring is chosen and tested to see if it is a unit — this
# is command ‘finverse:=Inverse(f);’. If inverse exists
# it is found and we
#then proceed to find the unit group ring code as described in elsewhere.
#From other considerations the inverse of f as constructed below always exists.

### F:=GF(3);

n;

### C_n:=CyclicGroup(n);

### C_{—}2:=CyclicGroup(2);

### DP:=DirectProduct(C_n, C_{—}2);

### RM:=FreeMagmaRing(F,DP);

### emb:=Embedding(DP, RM);

gens:=List( GeneratorsOfGroup(DP), x→x̂emb);

### s:=Size(gens);

x:=gens[1];
y:=gens [s];

### one:=Identity(RM);

f:=one +x̂2−x*y+x̂4*y;
finverse:=Inverse(f);

The RG matrix for this group ring has the form

$$( \begin{matrix}A & B \\ B & A\end{matrix} )$$

where A, B are circulant matrices (RG matrices corresponding to the cyclic group ring). Looking at the group ring form for f we see that A is the circulant matrix with first row (1, 0, 1, 0, . . . , 0) and B is the circulant matrix with first row (0, 1, 0, −1, 0, . . . , 0).

As f is ‘sparse’, we take f to give the check matrix and its inverse to give the generator matrix of a (2n, n) code, C say. The inverse of f in this case is not sparse and has the order of n non-zero coefficients. Thus the check matrix of the code C is (B^{t}|A^{t}). This check matrix has at most four non-zero entries in each row and column; the code is an LDPC code, verified dimension

Although preferred embodiments are disclosed herein, many variations are possible which remain within the concept, scope, and spirit of the invention, and these variations would become clear to those skilled in the art after perusal of this application.

### Mathematical Description

### Definition of Group Ring Code.

Let W be a submodule of the group ring RG. A group ring encoding of W is a mapping from W to RG where either x [symbol] xu or x [symbol] ux: for x∈W and fixed u in RG. If x [symbol] ux then it is a left group ring encoding while if x [symbol] xu then it is a right group ring encoding. A group ring code is the image of a group ring encoding.

Thus a group ring code is {ux:∀x∈W, u(fixed)∈RG} or {xu:∀x∈W, u(fixed)∈RG}.

In general x [symbol] xu and x [symbol] ux are different. If xu=ux for all x then we say that the code {xu} (or {ux}) is commutative; otherwise the code is said to be non-commutative.

When u is a zero-divisor we say the code is a zero-divisor (RG) code and when u is a unit we say that the code is a unit (RG) code. We shall consider zero-divisor codes of group rings of non-cyclic groups and unit codes. When R is a field every group ring code in RG is either a zero-divisor code or else a unit code.

The cases where W has dimension less than n will be considered and in many cases W will be the module generated by g₁, g₂, . . . , gᵣ for some r<n. However the case where W is the module generated by gᵢ_{₁}, gᵢ_{₂}, . . . , gᵢ_{ₜ}), with 1≦t<n and {i₁, i₂, . . . , iₜ} a subset of {1, 2, . . . , n} will also be useful. Note that W is a submodule and is not an ideal.

Connection with previous known codes. These new codes would appear on the surface to take longer to implement than previous known ones but this is not the case. As already noted an RG-matrix is known once the first row of the matrix is known and this serves to reduce considerably the time implementation of these codes. Previous codes use mappings β: R^{r}→Rⁿ with r<n. In the matrix form of group ring codes we have mappings F_{n×n}→F_{n×n} given by α: X [symbol] XU. Now X is an RG-matrix with entry 0 for each of the last n−r entries of the first row and X is determined by its first row. As XU is also an RG matrix it is determined by its first row. Thus the mappings β and α require the same number of calculations and the same time to implement.
It is also easy by this group ring method to generate new low density parity check (LDPC) check codes.
Self-dual codes have an easy interpretation as elements in group rings and are thus easy to generate by this method.

These particular codes have important applications and have been difficult to generate up to now.

### Group Ring Zero-Divisor Codes

Suppose uv=0 in RG where u≠0 and v≠0. Suppose the elements of G are {g₁, g₂, . . . , gₙ} and let W be the module generated by g₁, g₂, . . . , gᵣ. The case where W is the module generated by gᵢ_{₁}, gᵢ_{₂}, . . . , gᵢ_{ᵣ} is similar and is further treated below. Then the zero-divisor group ring code is given by w [symbol] wu or w [symbol] wu for w∈W.

Given a vector of elements (αhd 1, α₂, . . . , αᵣ) with αᵢ∈R and r≦n we encode this vector by letting

$$x = {\sum }_{i = 1}^{r} {α}_{i} {g}_{i}$$

and then the encoding is given by x [symbol] xu. If c is a codeword then clearly cv=0. Thus v is a check element and V is a check matrix.

We may assume that r≦rank U. The case where r=rank U is of particular interest and leads to full rank generator and check matrices.

Suppose now U has rank r and that V has rank n−r. Then y is a codeword if and only if Vy=0. If V has rank less than n−r then there exist RG matrices V₀=V, V₁, V₂, . . . , Vₜ with t<n−r such that y is a codeword if and only if Vᵢy=0 for i=0, 1, . . . , t. In many cases we can find a V of rank n−r in which case t=0. This follows from known properties of matrices and the structure of these RG matrices U, V.

### Dihedral Code as a General Example of a Zero-Divisor Code

An example of a zero-divisor code using the dihedral group of order 8 is given in the section on examples.

The construction of a general dihedral code of length 2n and dimension n is as follows.

The elements of the dihedral group G=D₂ₙ of order 2n can be listed as {1, b, b², bⁿ⁻¹, a, . . . , abⁿ⁻¹}.

Then setting

u=1+a+ab+ . . . +abⁿ⁻² and v=b+b²+ . . . +bⁿ⁻¹+abⁿ⁻¹ it is verified that uv=0.

The dihedral group, D₂ₙ of order 2n has RG-matrix

$$P = ( \begin{matrix}A & B \\ B & A\end{matrix} )$$

where A is a circulant matrix and B is Hankel-type matrix. Let us take A=Iₙ and B as follows:

$$B = ( \begin{matrix}1 & 1 & … & 1 & 0 \\ 1 & 1 & … & 0 & 1 \\ ⋮ & ⋮ & ⋮ & ⋮ & ⋮ \\ 0 & 1 & … & 1 & 1\end{matrix} )$$

It is easy to see that rank P is n. The matrix P is the RG-matrix corresponding to the group ring element u.

Consider P as a matrix over [symbol] ₂. The matrix Q is found from v and thus PQ=0—note that to get Q in this case replace each 0 in P by 1 and each 1 in P by 0.

This gives

$$Q = ( \begin{matrix}0 & 1 & 1 & … & 1 & 1 & 0 & 0 & … & 0 & 0 & 1 \\ 1 & 0 & 1 & … & 1 & 1 & 0 & 0 & … & 0 & 1 & 0 \\ ⋮ & ⋮ & ⋮ & ⋮ & ⋮ & ⋮ & ⋮ & ⋮ & ⋮ & ⋮ & ⋮ & ⋮ \\ 1 & 1 & 1 & … & 1 & 0 & 1 & 0 & … & 0 & 0 & 0 \\ 0 & 0 & … & 0 & 0 & 1 & 0 & 1 & 1 & … & 1 & 1 \\ 0 & 0 & … & 0 & 1 & 0 & 1 & 0 & 1 & … & 1 & 1 \\ ⋮ & ⋮ & ⋮ & ⋮ & ⋮ & ⋮ & ⋮ & ⋮ & ⋮ & ⋮ & ⋮ & ⋮ \\ 1 & 0 & … & 0 & 0 & 0 & 1 & 1 & 1 & … & 1 & 0\end{matrix} ) = ( E \vert F )$$

Q is the matrix corresponding to the group ring element v.

Then PQ=0 and Q gives the check matrix. Note that Q also has rank n and thus has the full possible rank.

Now consider the encoding α: [symbol] ₂ⁿ [symbol] [symbol] ₂²ⁿ given by P. The generator matrix (A, B), which is n×n and the check matrix is E^{t}, which is also n×n. This code has length 2n and dimension n and the rate is n/(2n)=½.

See also the next section where self-dual dihedral codes are considered.

### Self-Dual Type Codes

Suppose

$$u = {\sum }_{i = 1}^{n} {α}_{i} {g}_{i}$$

is an element in the group ring and U the corresponding RG-matrix. Define

$${u}^{t} = {\sum }_{i = 1}^{n} {α}_{i}^{′} {g}_{i}$$

where the αᵢ¹ are the elements, in order, of the first row of the transpose of U, U^{t}. If U is symmetric then clearly u^{t}=u and in this case we say that u is symmetric. It is easily seen that u is symmetric if and only if the coefficient of g equals the coefficient g⁻¹ in u for all elements g of the group G. This is an easy condition and is not a great restriction.

A self-dual group ring code is a code given by the encoding x [symbol] xu or x [symbol] ux where u satisfies uu^{t}=0. If u is symmetric then the condition for a self-dual group ring code is that u²=0.

Say a group ring code given by u is self-check if and only if u²=0.

It is now easy to produce new self-dual codes.

Consider a group ring element which has RG matrix of the form

$$P = ( \begin{matrix}A & B \\ B & A\end{matrix} )$$

where A, B are n×n matrices. This could be for the case of the direct product of cyclic groups of order n in which case both A, B are circulant matrices or for the case of the dihedral group of order 2n where A is circulant and B is Hankel-type.

If we take A=Iₙ and B satisfying

$${B}^{2} = I then ( \begin{matrix}A & B \\ B & A\end{matrix} ) * ( \begin{matrix}A & B \\ B & A\end{matrix} ) = 0$$

over [symbol] ₂. Then the code can be considered as one of dimension n and length 2n with generator matrix (A, B) and also has check matrix (A, B)^{t} since P²=0. If B is also symmetric then this code is self-dual.

An example of an n×n circulant symmetric matrix B, over [symbol] ₂, with n even and B²=I is one of the form

$$( \begin{matrix}0 & 1 & 1 & … & 1 \\ 1 & 0 & 1 & … & 1 \\ ⋮ & ⋮ & ⋮ & ⋮ & ⋮ \\ 1 & 1 & … & 1 & 0\end{matrix} )$$

When n=4 this gives the Hamming code.

An example of a Hankel-type matrix, n even, with B²=I is one of the form

$$B = ( \begin{matrix}1 & 1 & … & 1 & 0 \\ 1 & 1 & … & 0 & 1 \\ ⋮ & ⋮ & ⋮ & ⋮ & ⋮ \\ 0 & 1 & … & 1 & 1\end{matrix} )$$

Hankel-type matrices are automatically symmetric.

Note that if P²=0 then over [symbol] ₂, (P+I)(P+I)=I; this enables us to build further self-dual codes by replacing B by P+I (and A by the identity 2n×2n matrix) in the formula for P. We can thus proceed to produce an infinite sequence of such codes starting from one such.

Consider B as a matrix with the sequence 1, 0, 1, 1, 0, 0, 1, 1, 1, 0, 0, 0, . . . as its first row, finishing with the zeros. We take either B as a circulant matrix or as a Hankel-type matrix. Suppose the size of B is 2n=m(m−1) and we are working over [symbol] ₂. Then B²ⁿ=I and the matrix

$$P = ( \begin{matrix}A & C \\ C & A\end{matrix} )$$

where A=I₂ₙ and C=Bⁿ satisfies P²=0. This gives a self-check code when considered as a mapping [symbol] ₂ₙ→ [symbol] _{An}. For example when m=3 we get a (12, 6, 4) code. For other values of m we get new codes with good distance properties.

### Group Ring Unit Codes

We also get new and useful codes by looking at units in group rings.

This is a complete new method for constructing codes. Previous methods were in most cases zero-divisor cyclic codes.

This type of coding can be particularly useful when encryption and coding are required together.

Suppose u is a unit in the group ring RG where |G|=n and G={g₁, g₂, . . . gₙ}. First of all consider W to be the module generated by g₁, g₂, . . . , gᵣ with r<n so that an element in W is of the form

$$w = {\sum }_{i = 1}^{r} {α}_{i} {g}_{i} .$$

The situation where W={gᵢ_{₁}, gᵢ_{₂}, . . . , gᵢ_{ₜ}} is similar and is further treated below. We encode by w [symbol] wu or by w [symbol] uw; this gives a mapping from W to RG and is thus a mapping from R^{r} to Rⁿ.

Suppose the coding is given by w [symbol] wu. The case w [symbol] uw is similar. Then c is a codeword if and only if

$${cu}^{- 1} = {\sum }_{i = 1}^{r} {α}_{i} {g}_{i} , i . e .$$

if and only if the coefficients of gᵣ₊₁, . . . gₙ in cu⁻¹ are zero.

Call these unit group ring codes. We now describe how the generator and check matrices are obtained.

If w, u⁻¹ are considered as RG-matrices (wᵢⱼ) and (uᵢⱼ) respectively then looking at the coefficients of gᵣ₊₁, . . . gₙ we have the conditions:

$$( {w}_{11} , {w}_{12} , … , {w}_{1 n} ) * ( \begin{matrix}{u}_{1 , r + 1} & {u}_{1 , r + 2} & ⋯ & {u}_{1 , n} \\ {u}_{2 , r + 1} & {u}_{2 , r + 2} & ⋯ & {u}_{1 , n} \\ ⋮ & ⋮ & ⋮ & ⋮ \\ {u}_{n , r + 1} & {u}_{n , r + 2} & ⋯ & {u}_{n , n}\end{matrix} ) = ( 0 , 0 , … , 0 ) = {0}_{1 \times ( n - r )}$$

This is the check matrix condition. There are n−r conditions. It would appear that there are more check conditions, going down the matrix and picking out the zeros, but these are a consequence of the above.

Notice that these codes also have the advantage that multiplying by the inverse gives the original data as the first r entries, and the other n−r entries give the check matrix.

Group ring unit codes may also be considered in matrix form as follows. Suppose uv=1 in the group ring and let U, V respectively be the corresponding RG-matrices, which are n×n, say.

Suppose

$$U = ( \frac{A}{B} )$$

where A is r×n and

$$V = ( C \vert D )$$

where C is n×r and D is n×(n−r).

Then UV=I implies that AD=0. We see that A is the generator matrix and D^{t} is the check matrix for the group ring unit code which corresponds precisely to that stated above. To see that D^{t} is the check matrix note first of all that if x=uA then clearly xD=0. Suppose on the other hand xD=0 then we show as follows that x=uA for some 1×r vector u.

$$\begin{matrix}x = xVU \\ = x ( C \vert D ) ( \frac{A}{B} ) \\ = ( xC \vert xD ) ( \frac{A}{B} ) \\ = ( xC \vert 0 ) ( \frac{A}{B} ) \\ = xCA .\end{matrix}$$

Now xC=u is 1×r and x=xVU=uA as required. Thus D^{t} is the check matrix as usually described: x is a code word if and only if D^{t}x^{t}=0 if and only if xD=0.

Note that the check matrix D^{t} produced from this unit group ring has full allowable rank which means that if A, the generator matrix, has rank r then D^{t} (and D) has rank n−r.

It will be appreciated that this method here of constructing codes and generator and check matrices from a non-singular matrix corresponding to a unit in a group ring works for any non-singular (invertible) matrix and not just for RG matrices. This then is indeed a new invention for producing codes from non-singular matrices.

We may thus construct group ring unit codes as follows. Let RG be the group ring of a group G over the ring R—usually R is a field but it doesn't have to be. Find a unit u of RG, and the element v so that uv=1. Choose an integer r and take W={g₁, g₂, . . . gᵣ} (or W={gᵢ_{₁}, gᵢ_{₂}, . . . gᵢ_{ᵣ}}—see below). Then the unit code is described above and the generator and check matrices may be obtained from U and V.

Over a field it is known that every element in RG is either a zero-divisor or a unit and an algorithm exists for deciding whether a particular element is a unit or a zero-divisor.

Note also that we can in this way construct codes over the integers [symbol] which are also useful. What we need are units in [symbol] G and methods for constructing these are known.

### Other Submodules

Suppose now W is the module generated by the elements gₖ_{₁}, gₖ_{₂}, . . . , gₖ_{ᵢ} with 1≦k₁<k₂< . . . <kᵣ≦n so that W is the set of all

$${\sum }_{i = 1}^{r} {α}_{{k}_{i}} {g}_{{k}_{i}} .$$

Then define the code by the mapping w [symbol] wu (or w [symbol] uw) for wεW.

### Case u is a Unit

Suppose now u is a unit and that uv=1 and UV=I. We consider the code given by w [symbol] wu. We get generator and check matrices as follows.

Let A be the r×n matrix consisting of the k₁, k₂, . . . , kᵣ rows of U. Let D be the (n−r)×n matrix with the k₁, k₂, . . . , kᵣ columns of V deleted.

Then A is the generator matrix and D^{t} is the check matrix.

For the code w [symbol] we similarly get the generator and check matrices from V and U,

If kᵢ=i for each i then we have the first r rows and U; U is the first r rows of U and D is the last n−r columns of V and this corresponds to first case above.

It will be appreciated that this method of producing a code and generator and check matrices is works for non-singular matrices corresponding to unit group ring elements works for any non-singular matrix and not just for the non-singular matrices which correspond to unit group ring elements.

### u is a Zero-Divisor

Suppose now u is a zero-divisors: Here we have uv=0 and UV=0 where we take U to have rank r and V to have rank n−r. Suppose the encoding is w [symbol] wu; the case w [symbol] uw is similar.

We know that there are r rows of U which are linearly independent. Suppose now rows k₁, k₂, . . . , kₛ rows of U are linearly independent with s≦r. Then we can choose rows R′={k₁, k₂, . . . , kₛ, w₁, . . . , wᵣ₋ₛ} to be linearly independent. Let R be the matrix where the rows in R′ are placed in order taken from U. (The wᵢ rows do not necessarily come after the kⱼ rows.) Just fit them into the right order. Let Uᵣ be the matrix formed from R with the rows in order. Then Uᵣ has rank r and size r×n. There exists a n×r matrix C such that UᵣC=Iᵣ.

Form the matrix from the rows k₁, . . . , kₛ of U and call this Uₖ_{ₛ}. Our generator matrix A is then this Uₖ_{ₛ}.

To get the check matrix we delete the k₁, k₂, . . . , kₛ columns of C to get an n×(r−s) matrix, which we call Cᵣ₋ₛ. We now add this Cₙ₋ᵣ matrix to V to get a matrix which we call D. This D is an n×(n−s) matrix. It also has rank n−s and satisfies UᵣD=0. In fact y is a codeword if and only if D^{t}y^{t}=0.

Thus our check matrix is D^{t}.

Thus our generator matrix is Uₖ_{ₛ} and our check matrix is D^{t} which is obtained by adding certain r−s columns from C to the matrix Vₙ₋ᵣ.

### Advantage

The advantage here is that given uv=1 and UV=I we choose the rows of U to give us the type of code required or the code which has a required distance. The generator and check matrices are immediate once the rows are chosen.

### Types of Codes

While in no way limiting the scope of the invention, the reader may note that the following types of codes are among those of theoretical and practical importance:
Low Density Parity Check (LDPC) codes.
Self-dual type codes.
Orthogonal codes

By looking at the group rings method it is easy to find new and useful self-dual codes; self-dual codes have an easy interpretation as group ring codes.

LDPC codes have their own importance and it is relatively easy to find new and useful LPDC codes by looking at special types of group ring codes.

Coding Combined with Encryption

Unit group ring codes will be particularly useful for combining group ring public key cryptography and codes in one system. Suppose u is a unit which is a public key of Alice, say, so that its inverse u⁻¹ is known only to Alice. An encrypted message m is sent via the code determined by u. Not only is the message encrypted but it is also encoded via this map in such a way that only Alice knows the decoding matrix which is obtained from u⁻¹.

Error-correction and encryption can be combined in one operation. This has huge potential in terms of complexity reduction, costs savings in terms of chip design, not to mention the number of applications that will benefit from cheap secure (and reliable) communication.

### Orthogonal Unit Code

Suppose

$$U = ( \frac{A}{B} )$$

is an orthogonal matrix so that UU^{t}=I. Since

$${U}^{t} = ( {A}^{t} \vert {B}^{t} )$$

we see from above that the code generated by this unit in this block form has generator matrix A (the top part of U) and check matrix B (the bottom part of U). We refer to this code as an orthogonal unit code. It corresponds to finding a unit u in the group ring so that uu^{t}=1. If in u the coefficient of g and g⁻¹ are the same for all g∈G then u^{t}=u and the condition is that u²=1. There is no restriction on the size of A within U.

### Low Density Parity Check Codes

New Low Density Parity Check (LDPC) codes are easily obtained from group ring codes. It is required to find a zero-divisor code or unit code where the check element is ‘short’ or equivalently where the check matrix has ‘few’ non-zero elements in each row and column compared to the size of the matrix.

Sparse or LDPC group ring codes are obtained by finding a unit element u∈RG so that either u or u⁻¹ has only a small number of non-zero coefficients compared to the size of the group.

It is now easy to give a whole series of such codes from group rings.

There exist in non-commutative group rings units called bicyclic units which have nice properties and are relatively easy to construct. They exist in most non-commutative group rings.

Suppose a has order m in a group and define

$$\hat{a} = {\sum }_{i = 0}^{m - 1} {a}^{i} .$$

Then (1−a)â=0. Let b be any element in the group which does not commute with a. Then α=(1−a)bâ satisfies α²=0 and so u=1+α is a unit. u≠1 as b does not commute with a. Also u⁻¹=1−α. These are the bicyclic units.

The m, which is the order of a, does not have to be large compared to the order of the group generated by a, b so the resulting check matrix (and generator matrix) is ‘sparse’ as u⁻¹ and u are then ‘short’.

See example above under “Examples of Implementation” of LDPC codes using bicyclic units in dihedral groups.

Also constructed in the examples is an LDPC code using a unit group ring formed from the direct product of two cyclic groups which have excellent distance properties. Many other groups may also be used to generate new LDPC codes in this way.

The girth of the LDPC codes are important for decoding and new codes can be constructed with good girth.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A method of generating a code having properties specific to its intended use, the method comprising the steps of:
a) selecting a group from a set of groups;
b) selecting a ring from a set of rings;
c) forming a group ring from said select group and selected ring;
d) selecting a generator u element from said group ring, wherein said selection is based on the desired properties of the code to be generated; and
e) inputting said selected generator u element into a code generation process to obtain a corresponding check element.

2. The method of claim 1 wherein the code to be generated is a zero-divisor code of a non-cyclic group, and the step of selecting a generator element comprises selecting a zero-divisor element.

3. The method of claim 1 wherein the code to be generated is a unit code, and the step of selecting a generator element comprises selecting a unit element.

4. The method of claim 1 wherein the code to be generated is a low density parity check (LDPC) code, and the step of selecting a generator element u comprises selecting an element having a small number of non-zero coefficients compared to the size of the group.

5. The method of claim 1 wherein said desired properties of the code to be generated include code distance.

6. The method of claim 1 wherein said desired properties of the code to be generated include code length.

7. The method of claim 1 wherein said desired properties of the code to be generated include code rate.

8. The method of claim 1 further comprising the step of mapping said generator u element and said check element onto a corresponding pair of encoding and decoding matrices.

9. The method of claim 8 further comprising the step of using the encoding and decoding matrices to carry out an evaluation of the generated codes.

10. The method of claim 9 wherein the evaluation comprises calculating code rate.

11. The method of claim 9 wherein the evaluation comprises calculating code girth.

12. The method of claim 9 wherein the evaluation comprises calculating code distance.

13. The method of claim 9 further comprising repeating the steps:
selecting a group from a set of groups;
selecting a ring from a set of rings;
forming a group ring from said select group and selected ring;
selecting a generator u element from said group ring, wherein said selection is based on the desired properties of the code to be generated; and
inputting said selected generator u element into a code generation process to obtain a corresponding check element,
and using the results of the evaluation as feedback when carrying out the steps:
selecting a group from a set of groups; and
selecting a ring from a set of rings.

14. (canceled)

15. (canceled)

16. (canceled)

17. The method of claim 1 wherein the step of selecting a generator u element from said group ring, wherein said selection is based on the desired properties of the code to be generated further comprises the step of determining whether said selected generator element u is a zero-divisor element.

18. The method of claim 17 wherein the step of selecting a generator u element from said group ring, wherein said selection is based on the desired properties of the code to be generated further comprises the step of determining a matching element v of the group ring such that uv=0, if said selected generator element u is a zero-divisor element, or determining a matching element v of the group ring such that uv=1, if said generator element u is a unit element

19. The method of claim 18 wherein the step of inputting said selected generator u element into a code generation process to obtain a corresponding check element further comprises the step of inputting said matching element v into said code generation process.

20. Apparatus for generating a code having properties specific to its intended use, the apparatus comprising:
a) means for selecting a group from a set of groups;
b) means for selecting a ring from a set of rings;
c) means for forming a group ring from said select group and selected ring;
d) means for selecting a generator element u from said group ring, wherein said selection is based on the desired properties of the code to be generated; and
e) a code generator adapted to receive said selected generator element u and to generate a corresponding check element.

21. The apparatus of claim 20 wherein the code to be generated is a zero-divisor code of a non-cyclic group, and the means for selecting a generator element u is adapted to select a zero-divisor element.

22. The apparatus of claim 20 wherein the code to be generated is a unit code, and the means for selecting a generator element is adapted to select a unit element.

23. The apparatus of claim 20 wherein the code to be generated is a low density parity check (LDPC) code, and the means for selecting a generator element u is adapted to select an element having a small number of non-zero coefficients compared to the size of the group.

24. The apparatus of claim 20 wherein said desired properties of the code to be generated include code distance.

25. The apparatus of claim 20 wherein said desired properties of the code to be generated include code length.

26. The apparatus of claim 20 wherein said desired properties of the code to be generated include code rate.

27. The apparatus of claim 20 further comprising means for mapping said generator element u and said check element onto a corresponding pair of encoding and decoding matrices.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A method of generating a code having properties specific to its intended use, the method comprising the steps of:
a) selecting a generator element from a non-singular matrix wherein said selection is based on the desired properties of the code to be generated; and
b) inputting said selected generator element into a code generation process to obtain a corresponding check element.

44. (canceled)

45. (canceled)

46. (canceled)
